(19) United States
(12) Patent Application Publication
(10) Pub. No.: US 2015/0122673 A1
(43) Pub. Date: May 7, 2015

(54) MULTI-COMPONENT DISPENSER

(71) Applicant: Blessed Holdings, LLC, Chicago, IL (US)

(72) Inventors: Pavlos Loumbroukos, Chicago, IL (US); Israel Idonije, Chicago, IL (US); Kelley Speck, Chicago, IL (US)

(73) Assignee: Blessed Holdings, LLC, Chicago, IL (US)

(21) Appl. No.: 14/071,620

(22) Filed: Nov. 4, 2013

(51) Int. Cl. A47G 33/00; B65B 5/04; B65B 3/02; A47G 19/22; B31B 1/74

(52) U.S. Cl. CPC A47G 33/002; A47G 19/2205; B31B 1/74; B65B 3/02; B65B 5/04
USPC 206/217; 493/152; 53/452; 53/474

(57) ABSTRACT

A dispenser for holding multiple components and allowing separate sequential access to the components. For example, one component can be a wafer and one component can be wine for use in a Christian communion ceremony. A container has a first cavity defined therein and an opening. A first layer element covers the opening and has a first side that is removably attached to a portion of the container. A second layer is removably attached to a portion of a second side of the first layer, a portion of the second layer being not adhered to the second side of the first layer to thereby form a second cavity between the first layer and the second layer. A first tab is defined on an edge the first layer. A second tab is defined on an edge of the second layer and extends over the first tab and beyond a distal end of the first tab to facilitate sequential removal of the layer elements and sequential access to a component in the second cavity and the component in the first cavity.

### BACKGROUND

The disclosure relates to a dispenser having two or more distinct sealed compartments that can be used to respectively contain and dispense two different substances that may be required to be separated until just prior to use.

The Holy Communion is a Christian sacrament reenacted in accordance with Jesus' instruction that his followers remember him when he gave his disciples bread and wine. In most Christian churches, the Holy Communion involves, from a purely mechanical standpoint, eating a piece of bread followed by drinking a small amount of wine. This can require extensive preparation, especially in large congregations. For example, portions of bread, often in the form of wafers, must be placed on special serving plates or containers which are passed to the communicants and then collected. Also, the wine, or grape juice is dispensed from individual serving cups or from one or more centrally located common cups. For large groups or groups in non-conventional locations, such as battlefield chapels, or the like, preparation for Holy Communion can be very inconvenient.

Also, even when permanent conventional facilities are available, congregants are often concerned about contamination due to handling of the bread and wine. Further, the preparation and serving of the bread and wine to a large group of people can take a great deal of time, reducing the time allowed for other portions of the service.

To minimize the limitations noted above, it is known to individually package a single serving of wine, or a facsimile thereof such as grape juice, and a single wafer in a package having two compartments. For example, U.S. Pat. No. 5,746,312 discloses a dispenser having a small open-top cup adapted for containing wine. The cup is closed by a two-part lid within which the wafer is disposed. A top layer of the lid is first removed to access the wafer and a lower layer of the lid is later removed to allow drinking of the wine from the cup. This permits a user to partake in the Holy Communion in the proper sequential order, i.e. the bread followed by the wine. A tab on the upper layer is first grasped to peel back the upper layer and reveal the wafer, after which another tab is pulled upwardly to open the cup for access to the wine. However, the tab on the upper layer is disposed directly over the tab on the lower layer. Therefore, it can be difficult to pull the upper layer tab without also pulling the lower layer tab. This is especially difficult for people with arthritis or other physical conditions. The patent teaches that the tabs can be offset from each other around the periphery of the cup. However, this configuration is difficult and relatively expensive to manufacture. Further such a configuration still presents problems because, in view of the thin nature of the layers, it is difficult to determine which tab is on the upper layer tab and which tab is on the lower layer. Of course, if the user pulls the lower layer tab first, the wine is accessed before the wafer and not in the proper sequential order.

### BRIEF DESCRIPTION OF THE DRAWINGS

FIG. 1 is top view of a dispenser in accordance with an embodiment;

FIG. 2 is a side view of the dispenser of FIG. 1;

FIG. 3 is an enlarged view of area A of FIG. 2;

FIG. 4 is an enlarged view of area B of FIG. 2 in cross-section taken along line 4-4 on FIG. 1, and

FIG. 5 is a flowchart of a method for manufacturing a dispenser.

### DETAILED DESCRIPTION

While methods and apparatus are described herein by way of example, those skilled in the art recognize that the methods and apparatus are not limited to the embodiments or drawings described. It should be understood that the drawings and description are not intended to be limited to the particular form disclosed. Rather, the intention is to cover all modifications, equivalents and alternatives falling within the spirit and scope of the claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

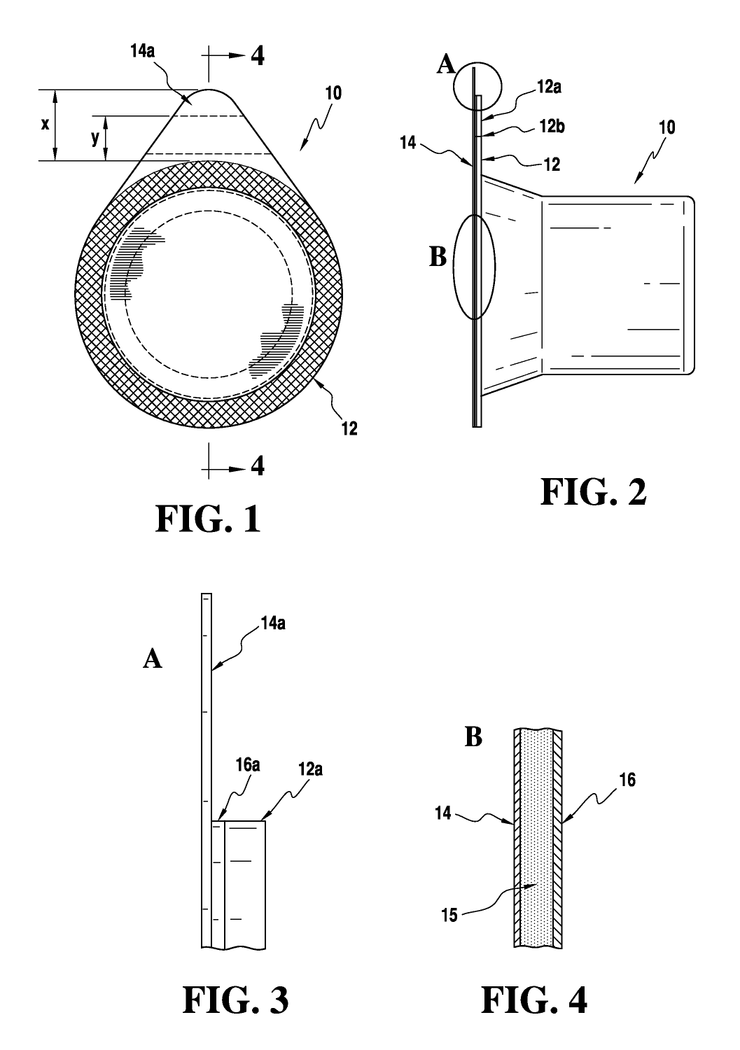

Referring to the drawings and particularly to FIG. 1, A dispenser is described. The dispenser includes container 10 which can be made of plastic or other suitable material, through thermoforming, injection molding, rotational molding stamping or other known processes and has a concave cavity portion defined therein which serves to contain a first material, such as grape juice or wine, in the case of the dispenser being used for communion. Flange portion 12 is formed on a top edge of container 10.

A peripheral portion of first layer 16 is adhered to flange portion 12 to seal the first material, such as grape juice or wine in the cavity portion of container 10. First layer 16 can be made of a paper-foil or paper-plastic material and can be heat-sealed, or otherwise removable attached to flange portion 12. A peripheral portion of second layer 14 is attached to first layer 16 to define a cavity between second layer 14 and first layer 16, as best shown in FIG. 4. A second material, such as wafer 15 in the case of communion, can be disposed between the layers 14 and 16 in a known manner. The term “wafer”, as used herein, refers to any substantially flat bread-like or cracker-like substance.

Second layer 14 can be distended upwardly, while first layer 16 is distended downwardly to define a cavity that receives wafer 15 (see FIG. 4), or another material, therebetween. Second layer 14 can be heat-sealed to the first layer 16 at a periphery (shown by cross hatching in FIG. 1) to form a cavity within which wafer 15 is held. First layer 16 and second layer 14 can be preassembled to define a package and then applied as a unit to flange 12 of container 10. Alternatively the layers can be individually applied to container 10. For example first layer 16 can be adhered to flange 12, after which second layer 14 is peripherally adhered on top of first layer 16 with wafer 15 there between. Various known methods and materials can be used for adhering the layers to the container and to each other. For example, adhesives, staples, or other mechanisms can be used.

As best illustrated in FIG. 2, flange 12 has extended tab 12a. Also, second layer 14 has tab portion 14a that extends beyond tab 12a of flange portion 12 and first layer 16 has tab 16a that substantially overlaps tab 12a of flange 12 (See FIG. 3). With reference to FIG. 3, it can be seen that tab 14a extends beyond tab 16a and tab 12a. Also, portions of tab 14a can be transparent or translucent to allow tab 16a to be visible therethorugh. As shown in FIG. 1, tab 14a extends radially to a length x beyond the main portion of flange 12 and tab 16a extends radially to a length y, which is less than x, beyond the main portion of flange 12. This arrangement makes it easy for a user to grasp and pull tab 14a, without disturbing tab 16a, to gain access to wafer 15 by peeling away second layer 14. Accordingly, wafer 15 can be accessed without disturbing the seal of first layer 16 and without spilling the wine contained in the cavity of container 10.

Note that, as illustrated in FIG. 2, tab 12a of flange 12 has scored portion 12b which is mechanically weaker than other portions thereof. Accordingly, after second layer 14 has been removed, first layer 14 can be removed be grasping tab 12a and tab 16a, breaking tab 12a at scored portion 12b and peeling back first layer 16. This provides access to the wine contained in the cavity of container 10. Alternatively, scored portion 12b of tab 12a can be eliminated and tab 16a can extend beyond tab 12a to permit grasping of tab 12a.

First layer 16 can be adhered to flange 12 more securely than second layer 14 is adhered to first layer 16 to insure that second layer 14 can be pulled off without unsealing the cavity of container 10. Also, various instructions or other printed material can be placed on the layers or between the layers. The container and layers can be adapted to hold various materials such as pharmaceuticals and chemicals that are used in association with one another.

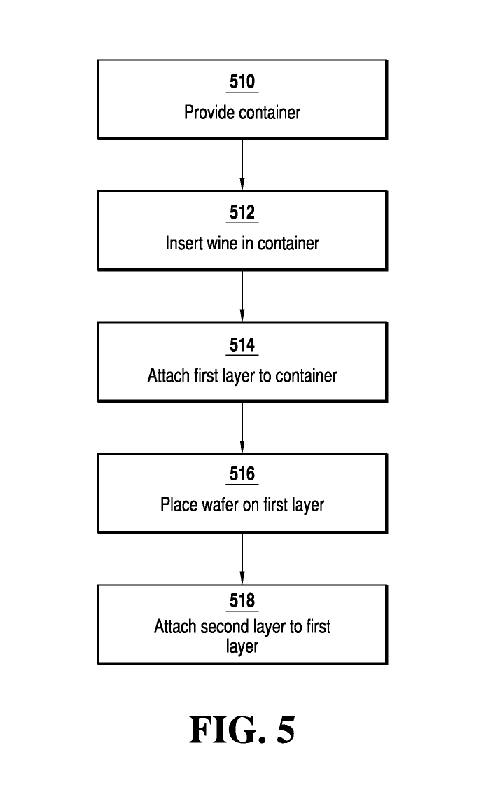

FIG. 5 illustrates a method of manufacturing the dispenser of FIGS. 1-4. In step 510, container 10 is provided. For example, container 10 can be formed through various known processes, such as stamping, injection molding, rotational molding, 3-D printing or the like. In step 512, a liquid, such as wine, is dispensed into the cavity of container 10. Again, this can be accomplished through known mechanized or manual processes. In step 514, first layer 16 is removably attached to flange 12 of container 10 using known adhesion techniques. In step 516, food, such as wafer 15, is placed on the surface of first layer 16. In step 518, second layer 14 is placed over wafer 15 and adhered to first layer 16 using known adhesion techniques.

Note that the steps described above do not need to be performed in the sequence described above. For example, wafer 15 can be disposed between layers 14 and 16, and layers 14 and 16 can be adhered to each other, to form a unitary package, before layer 16 is attached to container 10. The package can then be attached to container 10 as a single unit.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise.

In view of the many possible embodiments to which the principles of our invention may be applied, we claim as our invention all such embodiments as may come within the scope and spirit of the following claims and equivalents thereto.

What is claimed is:

1. A dispenser for holding multiple components and allowing separate sequential access to the components, the dispenser comprising:
a container having a first cavity defined therein and an opening;
a first layer element covering the opening and having a first side that is removably attached to a portion of the container;
a second layer removably attached to a portion of a second side of the first layer, a portion of the second layer being not adhered to the second side of the first layer to thereby form a second cavity between the first layer and the second layer;
a first tab defined on an edge the first layer; and
a second tab defined on an edge of the second layer and extending over the first tab and beyond a distal end of the first tab.

2. The dispenser of claim 1, wherein the portion of the container is a flange portion defined around the opening.

3. The dispenser of claim 2, further comprising a tab portion defined on the flange, the first tab extending substantially over the tab portion.

4. The dispenser of claim 3, wherein the first tab extends radially from the flange portion to the same length as the tab portion.

5. The dispenser of claim 3, wherein at least a portion of the second tab is made of a substantially transparent material.

6. The dispenser of claim 3, wherein the tab portion has a scored portion formed therein, whereby the tab portion can be broken at the scored portion to facilitate removal of the first layer.

7. The dispenser of claim 1, further comprising a beverage disposed in the first cavity and a food substance disposed in the second cavity.

8. The dispenser of claim 7, wherein the beverage is wine or grape juice and the food substance is a wafer.

9. The dispenser of claim 5, further comprising a beverage disposed in the first cavity and a food substance disposed in the second cavity.

10. The dispenser of claim 9, wherein the beverage is wine or grape juice and the food substance is a wafer.

11. The dispenser of claim 6, further comprising a beverage disposed in the first cavity and a food substance disposed in the second cavity.

12. The dispenser of claim 11, wherein the beverage is wine or grape juice and the food substance is a wafer.

13. A method for making a dispenser for holding multiple components and allowing separate sequential access to the components, the method comprising:
providing a container having a first cavity defined therein and an opening;
removably attaching a first side of a first layer element to a portion of the container to thereby cover the opening, a first tab being defined on an edge of the first layer; and
removably attaching a portion of a second layer to a portion of a second side of the first layer, a portion of the second layer being not adhered to the second side of the first layer to thereby form a second cavity between the first layer and the second layer, a second tab being defined on an edge of the second layer and extending over the first tab and beyond a distal end of the first tab.

14. The method of claim 13, wherein the portion of the container is a flange portion defined around the opening.

15. The method of claim 14, wherein a tab portion is defined on the flange, the first tab extending substantially over the tab portion.

16. The method of claim 15, wherein the first tab extends radially from the flange portion to the same length as the tab portion.

17. The method of claim 15, wherein at least a portion of the second tab is made of a substantially transparent material.

18. The method of claim 15, wherein the tab portion has a scored portion formed therein.

19. The method of claim 13, further comprising;
disposing a beverage in the first cavity; and
disposing a food substance in the second cavity.

20. The method of claim 19, wherein the beverage is wine or grape juice and the food substance is a wafer.

21. The method of claim 17, further comprising:
disposing a beverage in the first cavity; and
disposing a food substance in the second cavity.

22. The method of claim 21, wherein the beverage is wine or grape juice and the food substance is a wafer.

23. The method of claim 18, further comprising:
disposing a beverage in the first cavity; and
disposing a food substance in the second cavity.

24. The method of claim 23, wherein the beverage is wine or grape juice and the food substance is a wafer.

25. The method of claim 23, wherein the step of disposing a food substance in the second cavity is conducted before the step of removably attaching a first side of the first layer element to a portion of the container.
